(19) United States
(12) Patent Application Publication
(10) Pub. No.: US 2008/0299317 A1
(43) Pub. Date: Dec. 4, 2008

(54) ACRYLATE ADHESIVE MATERIAL AND METHOD OF USE THEREFOR

(76) Inventor: Christopher T. Hable, Romeo, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/754,674

(22) Filed: May 29, 2007

(51) Int. Cl. B05D 5/10; B32B 33/00

(52) U.S. Cl. 427/372.2; 428/355 R

(57) ABSTRACT

An adhesive material and method of using the material are disclosed. The adhesive material includes an admixture of acrylate or methacrylate monomer or both, a polymeric or oligomeric material, and a curing agent. The adhesive material may be formed into adhesive parts and may be dimensionally stable at ambient conditions.

### FIELD OF THE INVENTION

The present invention relates generally to an acrylate adhesive material and a method of use for the material and, more particularly, to a latent cure, dimensionally stable, structural acrylate adhesive material and method of using the material to adhere to surfaces.

### BACKGROUND OF THE INVENTION

Industry has developed numerous adhesives over the last several decades. In designing desirable adhesives, industry faces numerous problems and/or difficulties. For example, it can be desirable for an adhesive to be provided as a pre-formed part to avoid the use of bulky and potentially costly application equipment, such as pumping or other dispensing equipment that would otherwise be necessary and to allow shipment of parts-in-assembly. Adhesive chemistries may make it difficult to form such adhesive pre-formed parts. It may also be problematic to provide adhesive chemistries that are capable of adhering to substrates formed of certain types of materials or to substrates formed of multiple different types of materials. Many adhesives may also undergo cure at an appreciable rate when stored at ambient conditions, so that it may be difficult to provide adhesive materials with desirable shelf lives. Many adhesives that require external stimulus may require high cure temperatures, such that cure may only take place in high-temperature bakes.

The present invention, therefore, seeks to provide an improved adhesive material, which minimizes or eliminates one or more of the aforementioned problems or difficulties and/or other problems or difficulties. The present invention also seeks to provide a method of using the adhesive material where the method benefits from minimizing or eliminating one of the aforementioned problems or difficulties and/or other problems or difficulties.

### SUMMARY OF INVENTION

The present invention provides an adhesive material comprising (i) an admixture of acrylate or methacrylate monomer or both; (ii) a polymeric or oligomeric material; and (iii) a curing agent, wherein the adhesive material is dimensionally stable at ambient conditions.

An adhesive material in accordance with the present invention may be advantageous as compared to existing adhesive materials for several reasons. First, it may provide for the production of pre-formed, adhesive parts that are dimensionally stable at ambient temperature and may retain their shape at ambient temperature. Accordingly, the inventive adhesive material may be used in a variety of bonding operations, such that there is no need for costly pumping and dispensing equipment. Second, the inventive adhesive may be shipped part-in-assembly, thereby streamlining subsequent manufacturing. Third, the adhesive material may be latent at ambient temperature, thereby extending the shelf-life of the adhesive without requiring refrigeration. Fourth, the cure time and requisite cure temperature may be lower than with existing adhesive materials. Fifth, the inventive adhesive material may be used in various climates and may provide improved adhesion to a variety of substrates.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 is a perspective view of an adhesive part in accordance with an embodiment of the invention.

FIG. 2 is a side view of two members adhered together with adhesive material in accordance with an embodiment of the invention.

### DETAILED DESCRIPTION

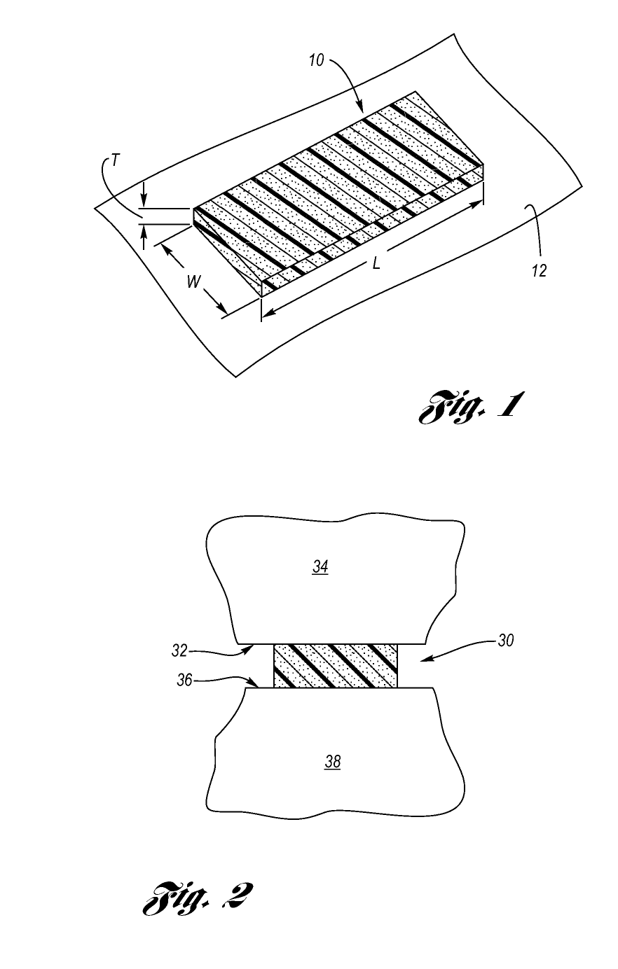

Referring now to the drawings, wherein like reference numerals designate corresponding parts throughout the views, FIG. 1 illustrates adhesive material 10 supplied on liner 12 in accordance with an embodiment of the invention. The present invention provides an improved adhesive material 10 and a method of using adhesive material 10. In an embodiment, adhesive material 10 may be configured to be formed into a part, the part having dimensional stability at ambient temperature. As used herein, a part having dimensional stability means that the part has a shape independent of a container and may be stored and manually handled without substantially affecting the shape of the part. In one embodiment, the dimensions of adhesive material 10 may increase or decrease by no more than 20% when stored under ambient conditions.

In an embodiment, adhesive material 10 may have at least two orthogonal dimensions greater than about 0.5 mm. In another embodiment, adhesive material 10 may have at least two orthogonal dimensions greater than about 1 mm. In another embodiment, adhesive material 10 may have at least two orthogonal dimensions greater than about 3 mm. As illustrated in FIG. 1, for example, adhesive material 10 may comprise a strip with a thickness T, width W, and length L. In an embodiment, thickness T may range from about 0.5 mm to about 3 mm. In an embodiment, width W may range from about 8 mm to about 100 mm. In an embodiment, length L may range from about 20 mm to about 20 m. Although these dimensions are mentioned in detail, it is understood by those of ordinary skill in the art that various dimensions may be utilized in accordance with the invention and remain within the spirit and scope of the invention.

Although adhesive material 10 is shown as a strip with three orthogonal directions, it is understood by those of ordinary skill in the art that adhesive material 10 may comprise any variety of shapes and forms and remain within the spirit and scope of the invention. Liner 12 may comprise a piece of release paper or a release liner on which adhesive material 10 may be supplied in an embodiment (e.g., if adhesive material 10 is tacky on at least a portion of an exterior surface of adhesive material 10). In other embodiments, adhesive material 10 may not be supplied on liner 12 (e.g., if adhesive material 10 is not tacky on at least a portion of an exterior surface of adhesive material 10). Adhesive material 10 may be configured to be removed from liner 12 for placement on or application to a surface or substrate. In other embodiments, a handling aid, as described in more detail below, may be located on adhesive material 10 so that an individual or machine may contact the handling aid for application of adhesive material 10. It is understood by those of ordinary skill in the art that adhesive material 10 may be tacky or substantially non-tacky, or non-tacky and remain within the spirit and scope of the invention.

Adhesive material 10 may be employed for a variety of purposes. For example, adhesive material 10 may be applied to various surfaces of articles of manufacture or substrates, including within a cavity, for adding structural integrity to portions or members of articles or for sealing the articles, for structurally adhering surfaces of members of one or more articles to each other, for baffling or providing acoustical damping properties, or any combination thereof. Examples of such articles of manufacture include, without limitation, household or industrial appliances, furniture, storage containers, buildings, structures, automotive vehicles, or the like. In some embodiments, the adhesive material may be applied to portions of an automotive vehicle such as a body panel or a structural frame member (e.g., a vehicle frame rail) of the automotive vehicle.

Adhesive material 10 may be structural. As used herein, structural means that adhesive material 10 may be capable of providing substantial bonding, stiffening, and/or reinforcing of joined assemblies under substantial loads. In one embodiment, adhesive material 10 may exhibit lap shear strengths of at least about 1000 psi when tested in accordance with the following test parameters according to SAE Method J1523: test adherends are 0.030 inch thick, 1 inch×4 inch EG-60 metal pre-cleaned with acetone; each adhesive bond line is 0.25 mm; test overlap dimension is 1 inch×0.5 inch; test rate is 0.5 inch/minute. In other embodiments, adhesive material 10 may exhibit lap shear strengths of at least about 1800 psi, at least about 2500 psi, and at least about 3000 psi using an SAE method as described above.

Referring now to FIG. 2, cured adhesive material 30 is illustrated in accordance with an embodiment of the invention. Cured adhesive material 30 refers to adhesive material 10 after cure has been initiated by an external stimulus, as described in more detail below. After its formation, adhesive material 10 may be manually placed on or applied to a surface or substrate, such as first surface 32 of first member 34 of an article of manufacture as shown in FIG. 2. In an embodiment, adhesive material 10 may be manually placed on or applied to a surface of an article or a substrate prior to shipping of the article or substrate. If adhesive material 10 is tacky on at least a portion of an exterior surface, adhesive material 10 may be self-adhering to first surface 32. If adhesive material 10 is non-tacky on at least a portion of an exterior surface, adhesive material 10 may be applied to first surface 32 with one or more fasteners, for example. A second surface 36 of a same or different member 38 of an article of manufacture may be placed on or applied to adhesive material 10. If adhesive material 10 is tacky, it may be self-adhering to second surface 36. If adhesive material 10 is non-tacky, it may be applied to second surface 36 with one or more fasteners, for example.

Adhesive material 10 may be exposed to external stimulus to initiate cure or activation. Once the adhesive material 10 has cured, cured adhesive material 30 may bond member 34 to member 38. Cured adhesive material 30 may provide a strong bond and connection between surfaces 32, 36. In an embodiment, adhesive material 10 may be applied to a surface, for example surface 32, 36, in an unactivated or partially activated state.

Adhesive material 10 may be acrylate based. As used herein, acrylate based is intended to mean that acrylate materials make up at least about 20% by weight of adhesive material 10. In other embodiments, acrylate materials may make up at least about 40%, at least about 50%, at least about 70%, at least about 80%, and at least about 85% by weight of adhesive material 10. In embodiments, acrylate material may be less than about 99.5%, less than about 98%, less than about 95%, less than about 92%, and less than about 90% by weight of adhesive material 10. It is understood by those of ordinary skill in the art that higher or lower amounts of acrylate materials may be included in adhesive material 10 and remain within the spirit and scope of the invention.

Acrylate materials may generally include any material, monomer, oligomer, polymer, molecule or the like that includes at least one acrylate group or moity in a reacted or unreacted state or in the polymerized or unpolymerized state. Examples of acrylate materials include, without limitation, acrylate compounds (e.g., acrylate salt, metal acrylate), acrylate monomer, acrylate oligomer, acrylate polymer, acrylate copolymer, acrylate impact modifier, acrylate functionalized polymer or oligomer, combinations thereof or the like. Acrylate materials can also include substituted acrylates such as methyl methacrylates and other alpha carbon substituted derivatives.

In an embodiment, adhesive material 10 may comprise an admixture of acrylate or methacrylate monomer or both, polymeric or oligomeric material, and a curing agent, wherein the adhesive material has dimensional stability at ambient temperatures. In other embodiments, adhesive material 10 may further comprise acrylate or methacrylate functionalized polymer, wherein the functionalized polymer has at least one acrylate functional group along a chain of the polymer or at a terminal end of the polymer or both. In other embodiments, adhesive material 10 may include one or more of the following: impact modifier, acrylate functional elastomer, metal acrylate salt, inorganic filler, or blowing agent.

Acrylate monomer is used herein to mean any chemical unit or molecule that includes an acrylate group and that can be reacted (e.g., repetitively reacted) to form an acrylate oligomer and/or polymer. Examples of acrylate monomers or oligomers include, without limitation, methyl methacrylate, isobornyl methacrylate, and tetrahydrofurfuryl methacrylate. Examples of acrylate monomers are those sold under the trademark SARTOMER® (e.g., designations SR423A, SR340, SR399) and are commercially available from Sartomer Company, Inc., 502 Thomas Jones Way, Exton, Pa. 19341. Although these examples of acrylate monomers or oligomers are mentioned in detail, it is understood by those of ordinary skill in the art that numerous other acrylate monomers or oligomers may be used and remain within the spirit and scope of the invention. The acrylate monomers of the present invention can be monofunctional, difunctional, multifunctional, or any combination thereof. Acrylate monomers with relatively high boiling points and low vapor pressures are preferred. Acrylate monomer may comprise at least about 10% by weight of adhesive material 10. It is understood by those of ordinary skill in the art that higher amounts of acrylate monomer may be included in adhesive material 10 and remain within the spirit and scope of the invention.

Acrylate functionalized polymer is used herein to mean any base polymer, whether an acrylate polymer or oligomer or other polymer, that includes a pendant acrylate functional group along the chain of the polymer, an acrylate functional group at one or both of the terminal ends of the chain of the polymer, or a combination thereof. As used herein, the former is referred to as an acrylate pendant polymer, the latter is referred to as an acrylate terminated polymer. Acrylate polymer or oligomer is used herein to mean any polymer or oligomer that is a polymerization product of acrylate monomers or oligomers. Acrylate polymer can include, without limitation, a simple acrylate polymer, methyl acrylate or methyl methacrylate polymer, ethyl acrylate polymer, butyl acrylate polymer, or the like. Although these examples of acrylate polymers are mentioned in detail, it is understood by those of ordinary skill in the art that numerous other acrylate polymers may be used and remain within the spirit and scope of the invention. Examples of base polymers suitable for use as acrylate functionalized polymers can include, without limitation, polyolefin, polyurethane, polyester, polyethylene, elastomer (e.g., urethane elastomer), epoxies, polybutadiene. Many of these base polymers are thermoplastic polymers that are functionalized with one or more terminal or pendant acrylate functional groups to provide them the capability of being thermoset, cross-linked or both. Nearly any polymer made with a terminal or pendant hydroxyl group can be converted to an acrylate or methacrylate, by reaction with acrylic or methacrylic acid respectively, and can be used in the present invention. It is understood by those of ordinary skill in the art that acrylate or methacrylate functionalized polymers may be made in various other ways.

Examples of suitable acrylate functionalized polymers include, without limitation, acrylate terminated thermoplastic polyurethane, acrylate terminated polyester, acrylate terminated urethane elastomer, any combination thereof or the like. Such acrylate functionalized polymers are sold under the trademark UVECOAT® (e.g., designation numbers 2100, 9146) and are commercially available from Cytec Surface Specialties, Five Garret Mountain Plaza, West Paterson, N.J., 07424. Although these examples of acrylate functionalized polymers are mentioned in detail, it is understood by those of ordinary skill in the art that numerous other acrylate functionalized polymers may be used and remain within the spirit and scope of the invention. The acrylate oligomers or polymers of the present invention can be monofunctional, difunctional, multifunctional or any combination thereof. The acrylate functionalized polymers of adhesive material 10 may be of sufficient molecular weight and/or sufficiently high softening point or melting point so that they are solid or semisolid under ambient conditions. In an embodiment, the acrylate functionalized polymers of adhesive material 10 may have a softening point greater than about 50° C. In other embodiments, the acrylate functionalized polymers of adhesive material 10 may have a softening point greater than about 60° C. or greater than about 70° C. The acrylate functionalized polymers of adhesive material 10 may assist in providing adhesive material 10 with dimensional stability as described herein, although it is understood by those of ordinary skill in the art that acrylate functionalized polymers are not required for adhesive material 10 to have dimensional stability.

Acrylate functionalized polymer may comprise at least about 1% by weight of adhesive material 10. In other embodiments, acrylate functionalized polymer may comprise at least about 6%, at least about 14%, at least about 20%, and at least about 27% by weight of adhesive material 10. In embodiments, acrylate functionalized polymer may be less than about 90%, less than about 65%, less than about 50%, less than about 38%, and less than about 33% by weight of adhesive material 10. It is understood by those of ordinary skill in the art that higher amounts of acrylate functionalized polymer may be included in adhesive material 10 and remain within the spirit and scope of the invention.

While adhesive material 10 may be acrylate based, such that all acrylate materials of adhesive material 10 make up at least about 20% by weight of adhesive material 10, in some embodiments, acrylate monomer, acrylate oligomer, acrylate polymer, acrylate functionalized polymer, alone or in combination, may comprise at least about 1% by weight of adhesive material 10. In other embodiments, acrylate monomer, acrylate oligomer, acrylate polymer, acrylate functionalized polymer, alone or in combination, may comprise at least about 10%, at least about 18%, at least about 28%, and at least about 35% by weight of adhesive material 10. In embodiments, acrylate monomer, acrylate oligomer, acrylate polymer, acrylate functionalized polymer, alone or in combination, may be less than about 90%, less than about 75%, less than about 60%, less than about 45%, and less than about 38% by weight of adhesive material 10. It is understood by those of ordinary skill in the art that higher and lower amounts of acrylate monomer, acrylate oligomer, acrylate polymer, acrylate functionalized polymer, alone or in combination, may be included in adhesive material 10 and remain within the spirit and scope of the invention.

Adhesive material 10 may be an activatable material. As used herein, the phrase activatable material includes any material that may be activated to melt, flow, cure (e.g., thermoset), expand, foam or a combination thereof by an ambient condition or another condition. For example, the material may expand, foam, flow, melt, cure, a combination thereof or the like upon exposure to a condition such a heat, pressure, chemical exposure, combinations thereof or the like. In accordance with the present invention, activation typically includes at least some level of curing.

Adhesive material 10 may include one or more curing agents and/or curing agent accelerators. The amounts of curing agents and/or curing agent accelerators may vary within adhesive material 10. In embodiments, curing agents and/or curing agent accelerators may range from about 0.001% by weight to about 7% by weight of adhesive material 10. In other embodiments, curing agents and/or curing agent accelerators may range from about 0.8% by weight to about 3% by weight of adhesive material 10.

The curing agent may assist adhesive material 10 in curing through the reaction of acrylate monomers and acrylate functional oligomers or polymers or both. Crosslinking or thermosetting of adhesive material 10 may occur through the reaction of acrylate monomers and acrylate functional oligomers or polymers or both. Peroxy compounds such as peroxide (e.g., organic peroxide) or hydro peroxide (e.g., organic hydro peroxide) may be used as the curing agent. Peroxides suitable for use in the present invention include without limitation, dialkyl peroxides, diacyl peroxides, peroxyketals, peroxyesters. In some embodiments, the curing agent may comprise peroxide on an inert carrier such as calcium carbonate.

Adhesive material 10 may be a latent curing material. As used herein, the term latent means that adhesive material 10 undergoes no substantial curing (i.e., less than about 10% of curing relative to total cure) under ambient conditions for up to 7 days. In other embodiments, adhesive material 10 may undergo no substantial curing (i.e., less than about 10% of curing relative to total cure) under ambient conditions for up to one month, up to 3 months, or even up to 6 months. In other embodiments, adhesive material 10 may undergo less than about 2% of curing relative to total cure under ambient conditions for up to 7 days, up to one month, up to 3 months, or even up to 6 months. In other embodiments, adhesive material 10 may undergo less than about 1% of curing relative to total cure under ambient conditions for up to 7 days, up to one month, up to 3 months, or even up to 6 months. Adhesive material 10 may therefore exhibit an extended shelf life as compared to existing adhesive materials. Exemplary performance of one shelf life of one adhesive material mixed according to the present invention is shown in Table I. Of course, such shelf life is not required of adhesive material 10 in order to remain within the spirit and scope of the invention. As used herein, ambient conditions means conditions commonly encountered without artificial climate control. This typically includes at least a temperature below about 50° C. and above about 0° C. Ambient conditions therefore include a temperature less than about 40° C. or 30° C. and above about 10° C. Some ambient conditions may include air oxygen levels between about 10% and about 30% by volume and/or humidity levels no greater than 95%, but only if such conditions are specifically recited.

TABLE I

| | Lap | T- | | | |
|---|---|---|---|---|---|
| Time After | Shear, | peel, | DSC Onset, | DSC Peak, | Exotherm, |
| Mixing, Days | psi | lb/in | ° C. | ° C. | J/g |
| 0 | 1734 | 23.90 | 122.28 | 128.91 | 115.3 |
| 14 | 1443 | 24.69 | | | |
| 30 | 1593 | 23.89 | | | |
| 60 | 1590 | 24.17 | | | |
| 90 | 1757 | 23.38 | 120.12 | 127.91 | 116.9 |
| 120 | 1619 | 23.42 | 120.49 | 128.3 | 106.7 |

In an embodiment, adhesive material 10 may be both a latent curing material and a heat curing material (i.e., a latent heat curing material). As used herein, the phrase “heat curing” means that the adhesive material 10 undergoes less than 20%, and more preferably less than 10%, of its total cure until activated by an external stimulus (e.g., exposure to a temperature greater than 80° C.). Once activated or during activation, adhesive material 10 may undergo at least 80% of total cure. Curing may be accomplished by exposure to heat, thermal energy, or electromagnetic radiation, including exposure to ultraviolet (UV) light with the addition of a UV photoinitiator.

Adhesive material 10 may be configured for use in a one-part bonding operation. In some embodiments, adhesive composition 10 may also include amino-borane complexes. Amino-borane complexes may be preferred for use in bonding plastics, including polyolefins and other low surface energy polymeric substrates. In an embodiment, adhesive composition 10 may include an organoboron compound and a stabilizing amount of one or more compounds comprising a dihydrocarbyl hydroxylamine, an alicyclic hydroxylamine, or a nitrite oxide of a dihydrocarbyl hydroxylamine or an alicyclic hydroxylamine. U.S. Patent Application Publication No. 2005/0004332A1, which is herein incorporated by reference describes amino-borane complexes, that may provide improved adhesion to plastics for adhesive material 10.

Adhesive material 10 may also include impact modifier. Impact modifiers may comprise materials capable of forming discrete, low Tg (i.e., glass transmition temperature) domains capable of crack blunting or crack bifurcation. In an embodiment, the glass transmition temperature of the domain may be at or below about −30° C. Impact modifiers may include block copolymers (e.g., SIS or SBS block copolymers available under the trademark KRATON® available from Kraton Polymers US, LLC). They may also comprise low molecular weight rubber (e.g., products available under the trademark HYCAR® VTBNX available from Emerald Performance Materials). The rubber may be functionalized, with the functional groups selected to be reactive with the resin system in use, in this case acrylate monomers. Exemplary impact modifier may include acrylate impact modifier, core/shell impact modifier or both (e.g., an acrylate core/shell impact modifier). Examples of core/shell impact modifier include, without limitation, core-shell graft copolymers where harder and/or higher glass transmition temperature monomers or polymers, such as styrene, acrylonitrile or methyl methacrylate, are grafted onto cores made from polymers of soft or elastomeric containing compounds such as butadiene or butyl acrylate. U.S. Pat. No. 3,985,703, which is herein incorporated by reference, describes useful core-shell polymers, the cores of which are made from butyl acrylate but can be based on ethyl isobutyl, 2-ethylhexyl or other alkyl acrylates or mixtures thereof. The core polymer may also include other copolymerizable containing compounds, such as styrene, vinyl acetate, methyl methacrylate, butadiene, isoprene, or the like. The core polymer material may also include a cross linking monomer having two or more nonconjugated double bonds of approximately equal reactivity such as ethylene glycol diacrylate, butylene glycol dimethacrylate, and the like. The core polymer material may also include a graft linking monomer having two or more nonconjugated double bonds of unequal reactivity such as, for example, diallyl maleate and allyl methacrylate. Although impact modifier is mentioned in detail, it is understood by those of ordinary skill in the art that impact modifier is not required for the inventive adhesive material.

Adhesive material 10 may also include additional polymeric materials which can include a variety of different polymers, such as thermoplastics, elastomers, plastomers, flexibilizers, combinations thereof, or the like. For example, polymers that might be incorporated into adhesive material 10 may include, without limitation, halogenated polymers, polycarbonates, polyketones, urethanes, phenoxy resin (e.g., thermoplastic polyethers), polyesters, silanes, sulfones, allyls, olefins, styrenes, acrylates, methacrylates, epoxies, silicones, phenolics, rubbers, polyphenylene oxides, terephthalates, acetates, or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate. The polymers may also include copolymers, terpolymers and the like. For example, and without limitation, copolymers and terpolymers that might be incorporated into adhesive material 10 may include, without limitation, ethylene acrylate copolymers and terpolymers (e.g. EMA and EMA-GMA), ethylene acetates (e.g. EVA), styrene butadiene copolymers, styrene isoprene copolymers, ethylene propylene copolymers and terpolymers (e.g. EP rubber or EPDM rubber), acrylonitrile butadiene copolymers. Although these variety of additional polymers are mentioned in detail, it is understood by those of ordinary skill in the art that these additional polymers are not required for the inventive adhesive material.

Adhesive material 10 may also include acrylate compounds such as acrylate salts, metal acrylates, or combinations thereof (e.g., a mixture of the two or an acrylate metal salt). These acrylate compounds may be provided to promote adhesion for bonding metallic substrates. Typically such compounds are included in relatively low amounts such as between about 0.1% and about 10% by weight of adhesive material 10. One suitable acrylate compound may be an acrylate metal salt sold under the trademark SARTOMER SR 633™, which is commercially available from Sartomer Company, Inc., 502 Thomas Jones Way, Exton, Pa. 19341. Although these acrylate salts and metal acrylates are mentioned in detail, it is understood by those of ordinary skill in the art that acrylate salts and metal acrylates are not required for the inventive adhesive material.

Adhesive material 10 may also include one or more fillers, including but not limited, to particulated materials (e.g., powder), beads, microspheres, or the like. Preferably, the filler includes a material that is generally non-reactive with the other components present in the adhesive material, although surface treated fillers with reactive functionalities may be used. While the fillers may be present within the adhesive material to take up space at a relatively low weight, it is contemplated that the fillers may also impart properties such as stiffness, strength, and impact resistance to the adhesive material. They may also be used to control tack and body and aid in the processing of adhesive material 10.

Examples of fillers, without limitation include silica, mica, diatomaceous earth, glass, clay (e.g., including nanoclay), calcium carbonate, wollastonite, talc, pigments, colorants, glass beads or bubbles, glass, carbon or ceramic fibers, nylon or polyamide fibers (e.g., KEVLAR®), antioxidants, and the like. Such fillers, particularly clays, can assist the adhesive material in leveling itself during flow of the material. The clays that may be used as fillers may include clays from the kaolinite, illite, chloritem, smecitite or sepiolite groups. The clays may be calcined or uncalcined. Examples of additional suitable fillers include, without limitation, talc, vermiculite, pyrophyllite, sauconite, saponite, nontronite, montmorillonite or mixtures thereof. The clays may also include minor amounts of other ingredients such as carbonates (e.g., calcium carbonate), feldspars, micas and quartz, which may be mineral, powder or stone type fillers. The fillers may also include organoclays. Titanium dioxide might also be employed.

When employed, the fillers in the adhesive material 10 may range from about 1% or less to about 50% or greater by weight of the adhesive material. In other embodiments, fillers may range from about 5% to about 15% by weight of the adhesive material. Although fillers are mentioned in detail, it is understood by those of ordinary skill in the art that fillers are not required for the inventive adhesive material.

One or more blowing agents may be added to adhesive material 10 for producing inert gasses that form, as desired, an open and/or closed cellular structure within the adhesive material. In this manner, it may be possible to lower the density of articles fabricated from the material. In addition, the material expansion can help to improve sealing capability, acoustic damping, adhesivity (e.g., wetting capability) or the like when desired. The blowing agent may include one or more nitrogen containing groups such as amides, amines and the like. Examples of suitable blowing agents include azodicarbonamide, dinitrosopentamethylenetetramine, azodicarbonamide, dinitrosopentamethylenetetramine, 4,4ᵢ-oxy-bis-(benzenesulphonylhydrazide), trihydrazinotriazine and N,Nᵢ-dimethyl-N,Nᵢ-dinitrosoterephthalamide. The blowing agent may also be a physical blowing agent such as a thermoplastic shell filled with an agent with a low boiling solvent. Upon heating the shell softens and the solvent volatilizes, causing and increase in volume of the shell. Blowing agents of this type are available under the trade name EXPANCEL®.

An activator for the blowing agents may also be provided in adhesive material 10. Various activators may be used to lower the temperature at which the blowing agents form inert gasses. One preferred blowing agent activator is a metal salt, or is an oxide (e.g., a metal oxide, such as zinc oxide). Other activators include organic acids and organic bases (e.g., urea).

Although blowing agents and blowing agent activators are mentioned in detail, it is understood by those of ordinary skill in the art that neither blowing agents nor blowing agent activators are required for the inventive adhesive material. However, when used, the amounts of blowing agents and blowing agent activators may vary widely within the adhesive material depending upon the type of cellular structure desired, the desired amount of expansion of the adhesive material, the desired rate of expansion and the like. Exemplary ranges for the amounts of blowing agents and blowing agent activators in the adhesive material range from about 0.001% by weight to about 10% by weight. In embodiments, the range for the amount of blowing agents and blowing agent activators may be in fractions of weight percentages. The blowing agents may be thermally activated. Other agents may be employed for realizing activation by other means, such as moisture, radiation, or otherwise. Adhesive material 10 may be activated for expanding (e.g., foaming) to a volume greater than its volume in the unexpanded state (e.g., at least about 5% greater, at least about 50% greater, at least about 200% greater, and at least about 1000% greater in various embodiments). In other embodiments relating to structural adhesion application, the volumetric expansion may be such that the expanded volume is less than about 800% relative to the original unexpanded volume. In other embodiments, the volumetric expansion may be less than about 500%, less than about 400%, and less than about 300% relative to the original unexpanded volume. It should also be understood that in some embodiments, adhesive material 10 does not expand during cure or activation.

It is understood by those of ordinary skill in the art that most nearly any additional chemicals, materials or otherwise, may be added to the adhesive material assuming they are suitable for the adhesive material and suitable for a chosen application of the adhesive material. As examples, additives, agents or performance modifiers may also be included in the adhesive material as desired, including but not limited to a UV resistant agent, a flame retardant, a heat stabilizer, a colorant, a processing aid, a lubricant, or a reinforcement (e.g., chopped or continuous glass, ceramic, aramid, or carbon fiber, particulates or the like).

When determining appropriate components for the adhesive material, it may be important to form the material such that it will only activate (e.g., flow, foam, cure or otherwise change states) at appropriate times or temperatures. Depending upon its intended application, adhesive material 10 may be applied and activated in different ways and at different times, as understood by those of ordinary skill in the art. For instance, in some applications, it is undesirable for the material to be reactive at room temperature or otherwise at the ambient temperature in a production environment. More typically, the adhesive material may become activated to flow, cure, and potentially foam at higher processing temperatures. As an example, temperatures such as those encountered in an automobile assembly plant may be appropriate, especially when the adhesive material is processed along with the other components at elevated temperatures or at higher applied energy levels, e.g., during painting preparation steps. Temperatures encountered in many coating operations (e.g., in a paint and/or e-coat curing oven), for instance, range up to about 250° C. or higher. In an embodiment, adhesive material 10 may be configured to cure at a temperature of only approximately 100° C., such that adhesive material 10 may be cured not only in a typical e-coat curing oven bake (e.g., body shop bake), but in a typical paint shop bake oven. As stated above, adhesive material 10 may also be configured to be activated at different times. In an embodiment, adhesive material 10 may be configured to cure within approximately 30 minutes after exposure to an external stimulus.

Exemplary adhesive materials of the present invention are in Table II below.

TABLE II

| | Percent of | Percent of | Percent of | Percent of |
|---|---|---|---|---|
| | Formula | Formula | Formula | Formula |
| Ingredient | Wt. % | Wt. % | Wt. % | Wt. % |
| Ethylene methacrylate copolymer | 0.0 | 0.0 | 15.00 | 15.00 |
| Acrylate terminated Polyurethane | 20.0 | 0.0 | 0.0 | 0.0 |
| Acrylate terminated Polyester | 0.0 | 20.0 | 0.0 | 0.0 |
| Acrylate Core/Shell Impact Modifier | 20.0 | 20.0 | 20.0 | 20.0 |
| Calcined Clay | 10.0 | 10.0 | 10.0 | 10.0 |
| Acrylate terminated Urethane | 10.0 | 10.0 | 15.0 | 15.0 |
| Elastomer | | | | |
| Monofunctional Methacrylate Monomer | 33.0 | 33.0 | 32.5 | 30.0 |
| Multifunctional Methacrylate Monomer | 3.0 | 3.0 | 4.0 | 6.0 |
| Acrylate Metal Salt | 2.0 | 2.0 | 2.0 | 2.0 |
| Curing agent (with inert carrier) | 2.0 | 2.0 | 1.5 | 2.0 |
| Results | | | | |
| DSC Onset, ° C. | 123 | 119 | 135 | 139 |
| DSC Peak, ° C. | 129 | 128 | 142 | 148 |
| Exotherm, J/g | 124 | 104 | 102 | 103 |
| Bake condition | 150° C. for | 120° C. for | 180° C. for | 180° C. for |
| | 30 minutes | 30 minutes | 30 minutes | 30 minutes |
| Lap Shear, (SAE 1523 @ 0.25 mm | 1811 psi | 1999 psi | 1080 psi | 1084 psi |
| bondline) | | | | |
| T-peel (ASTM D 1876 @ 0.25 mm | 22 lb/in | 33 lb/in | | |
| bondline) | | | | |

While Table II provides specific formulations, it is contemplated that weight percentages of the various components may be varied by +/−20%, by +/−50% or more. As an example, a weight percent of 10+/−20% is a range of 8 to 12 weight percent and such ranges are considered as part of the present invention. Moreover, components may be removed or added and components may be replaced.

Formation of the adhesive material may be accomplished according to a variety of new or known techniques. In one embodiment, the adhesive material may be formed as a material of substantially homogeneous composition. However, it is contemplated that various combining techniques may be used to increase or decrease the concentration of certain components in certain locations of the adhesive material.

According to one embodiment, the adhesive material may be formed by supplying the components of the material in solid form such as pellets, chunks, and the like, in liquid form or a combination thereof. The components are typically combined in one or more containers such as large bins or other containers. The containers may be used to intermix the components by rotating or otherwise moving the container. Thereafter, heat, pressure or a combination thereof may be applied to soften or liquidize the components such that the components can be intermixed by stirring or otherwise into a single homogenous composition.

According to another embodiment, the adhesive material may be formed by heating one or more of the components that are generally easier to soften or liquidize, such as the polymer based materials to induce those components into a mixable state. Thereafter, the remaining components may then be intermixed with the softened components.

Depending upon the components used, it may be important to assure that the temperature of the components remains below certain activation temperatures that might cause the adhesive material to activate (e.g., form gasses, flow, cure or otherwise activate) or both. Notably, when the adhesive material contains a blowing agent, it is typically desirable to maintain the temperature of the adhesive material below a temperature that will activate the blowing agent during formation of the adhesive material or before the adhesive material is applied to a surface. In situations where it is desirable to maintain the adhesive material at lower temperatures it may be desirable to maintain the components in a semi-solid or viscoelastic state using pressure or a combination of pressure and heat to intermix the components of the adhesive material. Various machines such have been designed to applying heat, pressure or both to materials during mixing or at other times. Equipment suitable for mixing the materials according to the invention include without limitation, twin screw extruders, single screw extruders, roll mills, cokneaders, sigma blade mixers, planetary mixers, Shaw mixers, and Bambury mixers. Post mixing processes to form the material into parts include without limitation, sheet die extrusion, profile extrusion, rotary die cutting, injection molding and the like.

Activation of the material may include at least some degree of foaming in situations where the adhesive material includes a blowing agent. Such foaming can assist the adhesive material in wetting a substrate and forming an intimate bond with the substrate. Alternatively, however, it shall be recognized that the adhesive material may be activated to flow without foaming and may still substantially wet the substrate to form an intimate bond. Formation of the intimate bond will typically but not necessarily occur or at least be enhanced upon curing of the adhesive material.

When the preformed adhesive material according to the present invention is tacky, handling of the material can be improved by application of a handling aid or backing material in the form of a scrim, structural coating, structural film or structural powder. By scrim is meant a light weight fabric, textile or gauze composed of fibers, threads, strands or yarn. The fibers, threads, strands, or yarns may be comprised of a polymeric material. The scrim may be of woven or non-woven construction but those of a non-woven construction are preferred. The scrim material may be of low enough weight g/yd² such that the fibers are spaced and overlapped in such a way as to leave spaces between the fibers, threads, strands or yarn. In one preferred embodiment, the scrim will exist as a discontinuous, permeable surface. It is understood by those of ordinary skill in the art, however, that the polymeric materials discussed below in relation to the scrim could be formed into a surface material of a different configuration such as film.

Polymeric materials for the scrim may be crystalline, semicrystalline or amorphous. Crystalline or semi-crystalline polymeric materials suitable for use in the invention will typically have a melting point, as measured by DSC (Digital Scanning Calorimeter), between about 40° C. and about 20° C., more typically between about 45° C. and about 150° C. and even more typically between about 50° C. and about 100° C. Amorphous polymeric materials suitable for use in the invention will have a softening point, as measured by thermo mechanical analysis (TMA) of preferably between about 40° C. and about 200° C., more preferably between 45° C. and about 150° C. and even more preferably between 50° C. and about 100° C. It is understood by those of ordinary skill in the art that higher or lower softening point material may be employed and remain within the spirit and scope of the invention.

The scrim material will typically have a weight per area between about 10 and about 50 g/yd², more typically between about 15 and about 40 g/yd² and even more typically between about 20 and about 35 g/yd². It is understood by those of ordinary skill in the art that higher or lower weight per area for the scrim material may be employed and remain within the spirit and scope of the invention. Generally, lower fabric weights may be desirable for weld through products, and higher weights may be desirable to achieve less stretching.

The polymeric material may be any material capable of being melt blown or melted spun to form the scrim. Exemplary polymeric materials which can be used to produce the scrim material are polymers or copolymer of polyesters, polyamides, polyolefins or the like. Exemplary scrim materials that are usable according to the invention are available sold under the trade designation PE 75-25 from Bostik under the designation of Web Adhesives. Although these polymeric materials are mentioned in detail, it is understood by those of ordinary skill in the art that other polymeric materials may be employed and remain within the spirit and scope of the invention.

When the handling aid or backing material is in the form of a coating, film or powder, it may be preferred that it contain correspondence components in its composition. U.S. Patent Application Publication No. 2004/0076831 A1, and U.S. Pat. No. 6,811,864 which are herein incorporated by reference, describe structural coatings, films and powders that may be added to adhesive material 10 to improve handling.

In another embodiment the handling may be improved by with a multi-stage cure, using UV light or other stimulus to partially cure one surface of the adhesive as described in U.S. Patent Application Publication No. 2004/0076831 A1.

Dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique materials herein and the operation thereof also constitute methods in accordance with the present invention.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims

What is claimed is:

1. An adhesive material, comprising:
i. an admixture of acrylate or methacrylate monomer or both;
ii. a polymeric or oligomeric material; and
iii. a curing agent,
wherein the adhesive material is dimensionally stable at ambient conditions.

2. An adhesive material in accordance with claim 1, wherein all or a portion of the polymeric or oligomeric material is comprised of an acrylate or methacrylate functionalized polymer or oligomer, wherein the functionalized polymer or oligomer has at least one acrylate functional group along a chain of the polymer or oligomer or at a terminal end of the polymer or oligomer or both.

3. An adhesive material in accordance with claim 1, wherein the acrylate or methacrylate monomer comprises at least about 20% by weight of the adhesive material.

4. An adhesive material in accordance with claim 1, wherein the acrylate or methacrylate monomer comprises methyl methacrylate, isobornyl methacrylate, or tetrahydrofurfuryl methacrylate.

5. An adhesive material in accordance with claim 2, wherein the functionalized polymer or oligomer comprises a thermoplastic, an elastomer, or a combination thereof.

6. An adhesive material in accordance with claim 1, wherein the polymeric or oligomeric material is solid or semisolid at ambient conditions.

7. An adhesive material in accordance with claim 1, wherein the acrylate monomer is monofunctional, difunctional, multifunctional, or a combination.

8. An adhesive material in accordance with claim 1, wherein the adhesive material is acrylate based, such that it is at least about 20% by weight acrylate or methacrylate based material.

9. An adhesive material in accordance with claim 1, wherein the curing agent comprises an organic peroxide, organic hydro peroxide, or a peroxy type curing agent.

10. An adhesive material in accordance with claim 9, wherein the curing agent comprises about 0.001% to about 7% by weight of the adhesive material.

11. An adhesive material in accordance with claim 1, wherein the adhesive material is latent at ambient conditions, such that the adhesive material undergoes less than about 10% of curing relative to total cure for up to 7 days at ambient conditions.

12. An adhesive material in accordance with claim 1, wherein the curing agent is activated by exposure to external stimulus.

13. An adhesive material in accordance with claim 12, wherein the external stimulus comprises thermal energy, electromagnetic radiation, or ultraviolet light, or a combination thereof.

14. An adhesive material in accordance with claim 1, wherein the adhesive material exhibits a lap shear strength of at least about 1000 psi after cure.

15. An adhesive material in accordance with claim 1, wherein the adhesive material includes at least two orthogonal dimensions greater than about 0.5 mm.

16. An adhesive material in accordance with claim 1, wherein the adhesive material comprises a formed strip.

17. An adhesive material in accordance with claim 1, further comprising an impact modifier.

18. An adhesive material in accordance with claim 17, wherein the impact modifier comprises acrylate polymer, methacrylate butadiene styrene (MS), acrylonitrile butadiene styrene (ABS), or a combination thereof.

19. An adhesive material in accordance with claim 1, further comprising a metal acrylate or acrylate salt or combination thereof.

20. An adhesive material in accordance with claim 1, further comprising an inorganic filler.

21. An adhesive material in accordance with claim 1, wherein the adhesive material is configured for use in a one-part bonding operation.

22. An adhesive material in accordance with claim 21, wherein the adhesive material comprises an amino-borane complex.

23. An adhesive material in accordance with claim 1, wherein the adhesive material is tacky on at least a portion of an exterior surface of the adhesive material.

24. An adhesive material in accordance with claim 23, wherein at least a portion of the tacky portion of the exterior surface of the adhesive material includes a handling aid for improving handling of the adhesive material.

25. An adhesive material in accordance with claim 24, wherein the handling aid comprises scrim, a coating, a film, or a powder.

26. An adhesive material in accordance with claim 24, wherein the handling aid is formed by a multi-stage cure process that partially cures at least a portion of an exterior surface of the adhesive material.

27. A method of using an adhesive material, comprising the following steps:
forming an adhesive material, the adhesive material comprising (i) an admixture of acrylate or methacrylate monomer or both; (ii) a polymeric or oligomeric material; and (ii) a curing agent, wherein the adhesive material is dimensionally stable at ambient conditions;
manually placing the adhesive material on at least one substrate; and
exposing the adhesive material to external stimulus to initiate cure of the adhesive material.

28. A method in accordance with claim 27, wherein the adhesive material cures within approximately 30 minutes after exposure to external stimulus.

29. A method in accordance with claim 27, wherein the adhesive material is configured to cure at a temperature of approximately 100° C.
